(19) United States
(12) Patent Application Publication
(10) Pub. No.: US 2026/0021488 A1
(43) Pub. Date: Jan. 22, 2026

(54) SYSTEM AND METHOD FOR ISOLATING LARGER MICROSCALE OBJECTS FROM SMALLER MICROSCALE OBJECTS WITHIN A FLUIDIC MEDIUM

(71) Applicant: The Curators of the University of Missouri, Columbia, MO (US)

(72) Inventor: Elliott Leinauer, Columbia, MO (US)

(21) Appl. No.: 19/272,176

(22) Filed: Jul. 17, 2025

Related U.S. Application Data
(60) Provisional application No. 63/672,922, filed on Jul. 18, 2024.

(51) Int. Cl. B01L 3/00

(52) U.S. Cl. CPC B01L 3/502761; B01L 2200/0652; B01L 2300/0809; B01L 2400/0633

(57) ABSTRACT

A microfluidic object isolation device comprising a top plate, a bottom plate, at least one elastomeric perimeter wall disposed therebetween and defining an interior chamber, an array of elastomeric microstructures within the interior chamber, the microstructures spaced apart thereby defining microchannels between adjacent microstructures, wherein the fluid flow microchannels comprise object bypass zones and object capture zones, an ingress port structured and operable to ingress a fluidic medium into the interior chamber, the fluidic medium comprising large microscale objects and small microscale objects, and an egress port. The microfluidic object isolation device is compressible from a static state to a capture state whereby the microstructures are compressed to alter the fluid flow microchannels from a static shape and size to a capture shape and size whereby the large microscale objects of the fluidic medium are captured within the object capture zones.

### CROSS-REFERENCE TO RELATED APPLICATIONS

This application claims the benefit of U.S. Provisional Application No. 63/672,922, filed on Jul. 18, 2024, the disclosure of which is incorporated herein by reference in its/their entirety.

### FIELD

The present teachings relate to microfluidic microparticle isolation technologies, more particularly to systems and methods for recovering viable cancer cells at higher efficiencies and throughput.

### BACKGROUND

The statements in this section merely provide background information related to the present disclosure and may not constitute prior art.

Label-free microfluidic object isolation technologies are broadly classified into active and passive categories. Active isolation methods use external forces (e.g., acoustic waves and magnetic pulses) to achieve highly efficient object isolation. However, these external forces may damage object (e.g., blood cells, cancer cells), allowing detection but no further analysis. Additionally, active methods typically require low flow rates (i.e., μL/min) to generate sufficient forces to isolate the microscale objects (e.g., blood cells, cancer cells).

### SUMMARY

The present disclosure generally provides a passive microscale object isolation system and method that depends on fluid flow characteristics of a fluidic medium (e.g., a biological sample such as a blood sample) in an elastomeric bi-stable microchannel. The fluidic flow is controlled by uniquely designed microchannels containing various curves and angles. The microchannels are defined or formed by an elastomeric bi-stable microstructure array formed within a device that isolates microscale objects in the fluidic medium (e.g., cells such as red blood cells (RBCs) and circulating tumor cells (CTCS) in the blood sample). More particularly, the present disclosure introduces a system, device and method that regulates the secondary flow development for highly efficient object isolation, capture, and release of microscale objects from a fluidic medium (e.g., CTCs in a biological sample such as a blood sample). The system, device and method provide high efficiency in both the capture and release of the objects from the fluidic medium. A critical innovation of the present disclosure is the array of elastomeric bi-stable microstructures designed with unique curves and angles and unique cross-sectional geometries that define the fluid flow channels. When an external load is applied to the array of microstructures, the walls of the fluid flow channels contract vertically and the cross-sectional area of the fluid flow channels that initially have large cross-sectional reduces to achieve a nearly uniform cross-sectional shape (i.e., a rectangle, a square, a triangle, etc.) that generates secondary flows for object isolation and subsequent capture. Subsequently, once the compression is relaxed, the microstructures change back to their original shapes and the fluid flow channels return to their original cross-sectional geometries whereby the fluid flow conditions are manipulated to provide high fluidic velocity and continuity that suppress the development of secondary flow and allows for the efficient release and recovery of captured objects.

For example, in various embodiments the present disclosure provides a microfluidic object isolation device that generally comprises a top plate, a bottom plate, and at least one elastomeric perimeter wall disposed between the top and bottom plates around a perimeter of the top and bottom plates and defining an interior chamber. The microfluidic object isolation device additionally comprises an array of elastomeric microstructures formed between the top and bottom plates within the interior chamber, wherein the elastomeric microstructures spaced apart such that fluid flow microchannels are defined between adjacent elastomeric microstructures. The fluid flow microchannels comprise a plurality of object bypass zones and a plurality of object capture zones. The microfluidic object isolation device further comprises an ingress port structured and operable to ingress a fluidic medium into the interior chamber, the fluidic medium comprising large microscale objects and small microscale objects, and an egress port structured and operable to egress the fluidic medium from the interior chamber. The microfluidic object isolation device is compressible from a static state to a capture state whereby the elastomeric microstructures are compressed to alter the fluid flow microchannels from a static shape and size to a capture shape and size whereby the large microscale objects of the fluidic medium are captured within the object capture zones.

In various other embodiments, the present disclosure provides a system for isolating large microscale objects from small microscale objects in a fluidic medium and capturing the large microscale objects, that comprises a load transmission assembly press, wherein the press includes a top platen, a compression platen, a base platen, and a compression load assembly. The system additionally comprises a microfluidic object isolation device, wherein the microfluidic object isolation device includes a top plate, a bottom plate, at least one elastomeric perimeter wall disposed between the top and bottom plates around a perimeter of the top and bottom plates and defining an interior chamber. An array of elastomeric microstructures are formed between the top and bottom plates within the interior chamber and are spaced apart such that fluid flow microchannels are defined between adjacent elastomeric microstructures. The fluid flow microchannels comprise a plurality of object bypass zones and a plurality of object capture zones. The microfluidic object isolation device additionally includes an ingress port structured and operable to ingress a fluidic medium into the interior chamber, wherein the fluidic medium comprising large microscale objects and small microscale objects, and an egress port structured and operable to egress the fluidic medium from the interior chamber. The system further comprises a load transmission assembly removably disposable between the top platen and the base platen. The load transmission assembly is structured and operable to receive the microfluidic object isolation device in a static state. The compression load assembly is structured and operable to move the compression platen to compress the load transmission device such that the microfluidic object isolation device is compressed from the static state to a capture state whereby the elastomeric microstructures are compressed to alter the fluid flow microchannels from a static shape and size to a capture shape and size whereby the large microscale objects of the fluidic medium are captured within the object capture zones.

In yet other embodiments the present disclosure provides a method for separating large microscale objects from small microscale objects in a fluidic medium and capturing the large microscale objects. In various instances the comprises compressing at least a portion of an array of elastomeric microstructures of a microfluidic object isolation device such that at least a portion of fluid flow microchannels defined by the elastomeric microstructures are altered from a static shape and size when the elastomeric microstructures are uncompressed to a capture shape and size when elastomeric microstructures are compressed. The microfluidic object isolation device comprises a top plate, a bottom plate, at least one elastomeric perimeter wall disposed between the top and bottom plates around a perimeter of the top and bottom plates and defining an interior chamber, the array of elastomeric microstructures formed between the top and bottom plates within the interior chamber, wherein the elastomeric microstructures spaced apart such that the fluid flow microchannels are defined between adjacent elastomeric microstructures. The fluid flow microchannels comprise a plurality of object bypass zones and a plurality of object capture zones. The microfluidic object isolation device additionally comprises an ingress port structured and operable to ingress the fluidic medium into the interior chamber, and an egress port structured and operable to egress the fluidic medium from the interior chamber.

The method additionally comprises ingressing a fluidic medium comprising large microscale objects and small microscale objects into the interior chamber of a microfluidic object isolation device via the ingress port such that the fluidic medium flows through the fluid flow microchannels, and separating the large microscale objects from the small microscale objects via flow vortices generated by the capture shape and size of the compressed fluid flow microchannels. The method further comprises directing the small microscale objects into the bypass zones of the compressed fluid flow microchannels, and directing the large microscale objects into the capture zones of the compressed fluid flow microchannels via the flow vortices generated by the capture shape and size of the compressed fluid flow microchannels such that the large microscale objects are captured within the capture zones of the compressed fluid flow microchannels. The method still further comprises egressing the small microscale objects from the interior of a microfluidic object isolation device via the egress port, and decompressing the at least a portion of the array of elastomeric microstructures of a microfluidic object isolation device such that the at least a portion of fluid flow microchannels are altered from the capture shape and size to the static shape and size such that large microscale objects are released from within the capture zones of the uncompressed fluid flow microchannels, and egressing the large microscale objects from the interior of a microfluidic object isolation device via the egress port.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### BRIEF DESCRIPTION OF DRAWINGS

The drawings described herein are for illustration purposes only and are not intended to limit the scope of the present teachings in any way.

FIG. 1 is an exemplary isometric illustration of a microscale object isolation system for isolating or separating larger microscale objects from small microscale objects in a fluidic medium and capturing the larger microscale objects, in accordance with various embodiments of the present disclosure.

FIG. 2 is an exemplary isometric illustration of a load transmission assembly press of the microscale object isolation system shown in FIG. 1, in accordance with various embodiments of the present disclosure.

FIG. 3 is an exemplary isometric illustration of a load transmission device of the microscale object isolation system shown in FIGS. 1 and 2, in accordance with various embodiments of the present disclosure.

FIG. 4 is an exemplary isometric illustration of a side view of the microscale object isolation system shown in FIGS. 1, 2 and 3 having a microfluidic object isolation device disposed within the load transmission device, wherein the load transmission assembly press is in a non-actuated state such that the microfluidic object isolation device is in a static state (i.e., non-compressed state), in accordance with various embodiments of the present disclosure.

FIG. 5 is an exemplary isometric illustration of a side view of the microscale object isolation system shown in FIGS. 1, 2, 3 and 4 having the microfluidic object isolation device disposed within the load transmission device, wherein the load transmission assembly press is in an actuated state such that the microfluidic object isolation device is in a compressed state, in accordance with various embodiments of the present disclosure.

FIG. 6 is a top view of the microfluidic object isolation device shown in FIGS. 4 and 5, wherein a top plate of the microfluidic object isolation device has been removed or is transparent to exemplarily illustrate an array of elastomeric bi-stable microstructures disposed on a bottom plate of the microfluidic object isolation device within an interior chamber defined by an elastomeric perimeter wall of the microfluidic object isolation device, in accordance with various embodiments of the present disclosure.

FIG. 7 is a top view of a section of the microfluidic object isolation device shown in FIGS. 4, 5 and 6, wherein the top plate has been removed or is transparent to exemplarily illustrate the array of elastomeric bi-stable microstructures disposed within the microfluidic object isolation device, in accordance with various embodiments of the present disclosure.

FIG. 8A is a top view of one of the elastomeric bi-stable microstructures shown in FIG. 7 illustrating an exemplary shape of the elastomeric bi-stable microstructures, in accordance with various embodiments of the present disclosure.

FIG. 8B is a top view of one of the elastomeric bi-stable microstructures shown in FIG. 7 illustrating an exemplary shape of the elastomeric bi-stable microstructures, in accordance with various other embodiments of the present disclosure.

FIG. 8C is an isometric top view of one of the elastomeric bi-stable microstructures shown in FIG. 7 illustrating an exemplary shape of the elastomeric bi-stable microstructures, in accordance with various other embodiments of the present disclosure.

FIG. 9 is an exemplary illustration of one of a plurality of mirror-imaged pairs of elastomeric bi-stable microstructures of the array of elastomeric bi-stable microstructures shown in FIG. 7, wherein pair comprises two of the elastomeric bi-stable microstructures arranged as mirror images of each other, in accordance with various embodiments of the present disclosure.

FIG. 10 is an exemplary illustration of a portion of the array of elastomeric bi-stable microstructures shown in FIG. 9 illustrating the flow paths of the larger and smaller microscale objects resulting from a secondary flow generated by compression of the elastomeric bi-stable microstructures, in accordance with various embodiments of the present disclosure.

FIG. 11 is a cross-sectional view of a portion of the microfluidic object isolation device shown in FIGS. 1, 4, 5 and 6, wherein a portion of a pair of adjacent elastomeric bi-stable microstructures are shown exemplarily illustrating the cross-sectional shape of a large object capture zone of fluid flow channels formed between the adjacent elastomeric bi-stable microstructures by the perimeter sidewalls of the adjacent elastomeric bi-stable microstructures when the microfluidic object isolation device and the pair of adjacent elastomeric bi-stable microstructures are in an uncompressed static state, in accordance with various embodiments of the present disclosure.

FIG. 12 is a cross-sectional view of a portion of the microfluidic object isolation device shown in FIGS. 1, 4, 5, 6 and 11, wherein the portion of a pair of adjacent elastomeric bi-stable microstructures are shown exemplarily illustrating the cross-sectional shape of a large object capture zone of fluid flow channels formed between the adjacent elastomeric bi-stable microstructures by the perimeter sidewalls of the adjacent elastomeric bi-stable microstructures when the microfluidic object isolation device and the pair of adjacent elastomeric bi-stable microstructures are in a compressed state, in accordance with various embodiments of the present disclosure.

FIG. 13 is an exemplary illustration of a fluid flow within a microchannel formed between a pair of adjacent elastomeric bi-stable microstructures when the microchannel and the pair of adjacent elastomeric bi-stable microstructures are in a compressed state, in accordance with various embodiments of the present disclosure.

FIG. 14 is an exemplary illustration of the fluid flow within the microchannel formed between the pair of adjacent elastomeric bi-stable microstructures as shown in FIG. 13 only when the microchannel and the pair of adjacent elastomeric bi-stable microstructures are in an uncompressed static state, in accordance with various embodiments of the present disclosure.

FIG. 15 is an exemplarily isometric cross-sectional view of two adjacent microfluidic object isolation devices illustrating a curved object bypass zone of an exemplary microchannel defined therebetween, wherein the path and direction of a main flow and a secondary flow within the microchannel is illustrated, in accordance with various embodiments of the present disclosure.

FIG. 16 is an exemplary illustration of a portion of the array of adjacent elastomeric bi-stable microstructures in the compressed state exemplarily illustrating the separation and travel paths of the larger and smaller microscale objects generated by the secondary flow created by transitioning the array from the static state to the compression state, in accordance with various embodiments of the present disclosure.

FIG. 17 is an exemplary illustration of a portion of the array of adjacent elastomeric bi-stable microstructures in the static state exemplarily illustrating the flushing of captured larger microscale objects from the array, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

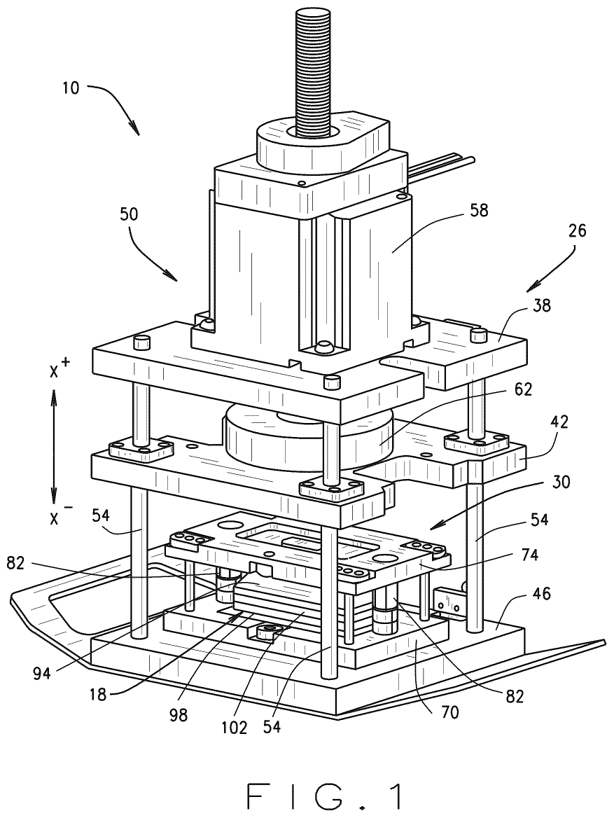

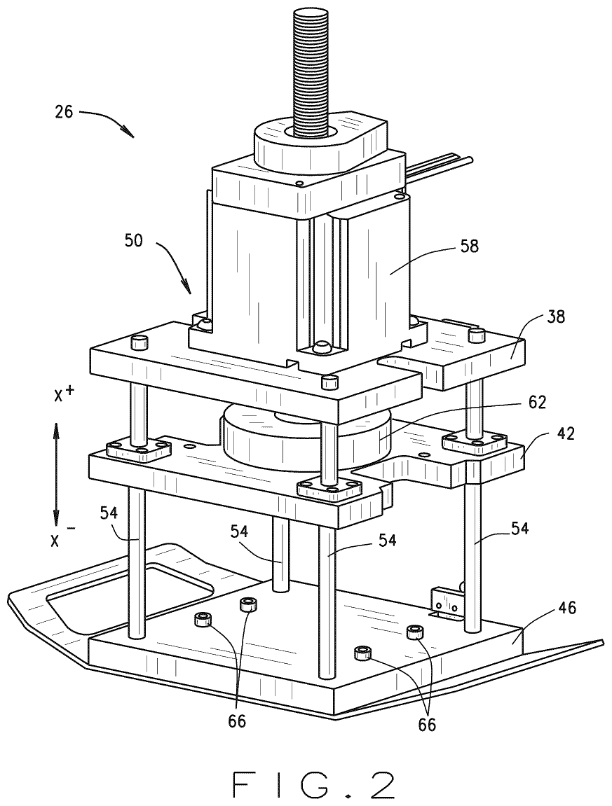

Referring to FIGS. 1, 2 and 3, the present disclosure provides a microscale object isolation system 10 that is structured and operable to isolate or separate larger microscale objects (LMOs) from smaller microscale objects (SMOs) within a fluidic medium and capture the larger microscale objects by regulating secondary flow using inertial microfluidics. As used herein the term microscale objects will be understood to mean objects having a micrometer scale size. In various embodiments the microscale object isolation system 10 can be structured and operable to isolate or separate larger microscale objects from smaller microscale objects within a biological fluid and capture the larger microscale objects. As a particular example, in various embodiments the microscale object isolation system 10 can be structured and operable to isolate or separate larger cancer cells (circulating tumor cells (CTCs)) from smaller red blood cells (RBCs) within a blood sample to collect the larger CTCs. In various embodiments, the system 10 can be utilized in various applications such as diagnosis and treatment of diseases such as cancer. Particularly, viable CTCs isolated from patient blood using the system 10 facilitate the generation of patient-derived CTC expansion models (e.g., xenograft mouse models, 3D tumor organoids) enabling clinicians to develop personalized treatment plans and perform drug sensitivity testing. In addition to isolating clinically valuable immune cells such as macrophages for chimeric antigen receptor macrophage (CAR-M) immunotherapy. Beyond mammalian cells, various embodiments of the system 10 can be structured and operable to isolate or separate plants cells (e.g., microspores, pollen, protoplast) for downstream culturing, metabolite screening, and genetic modification.

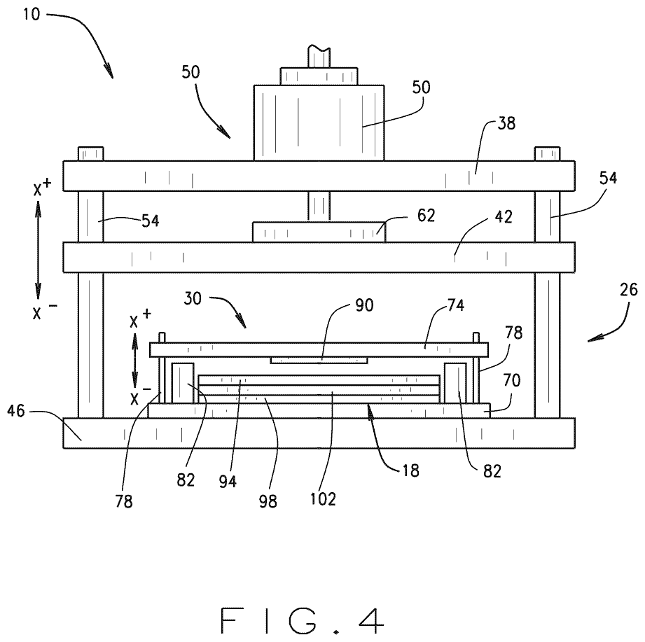

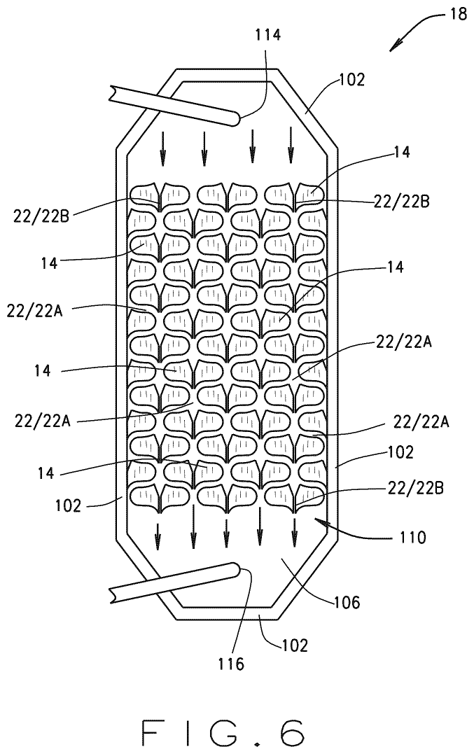

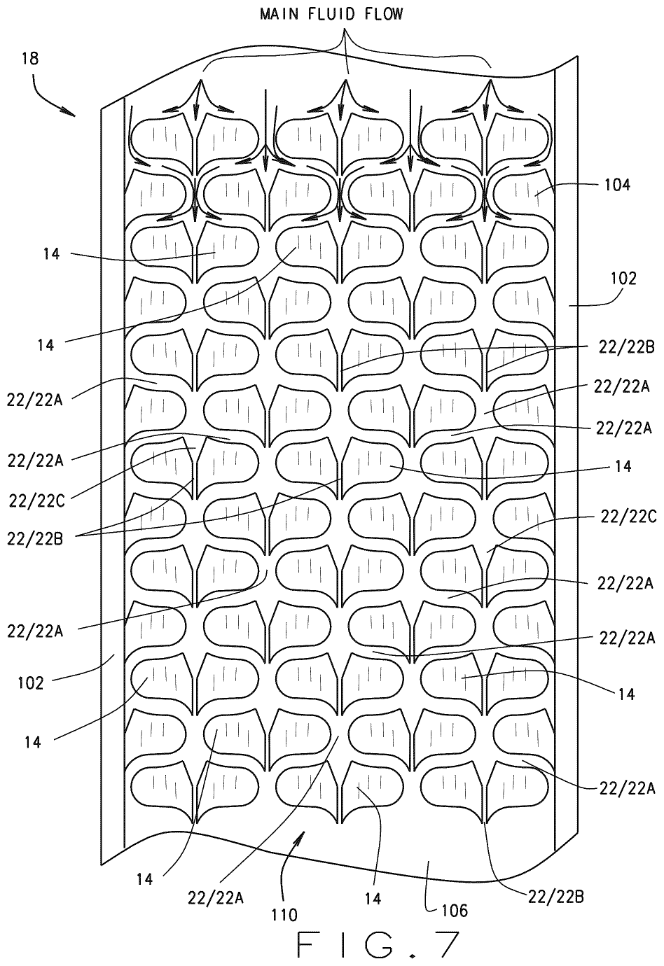

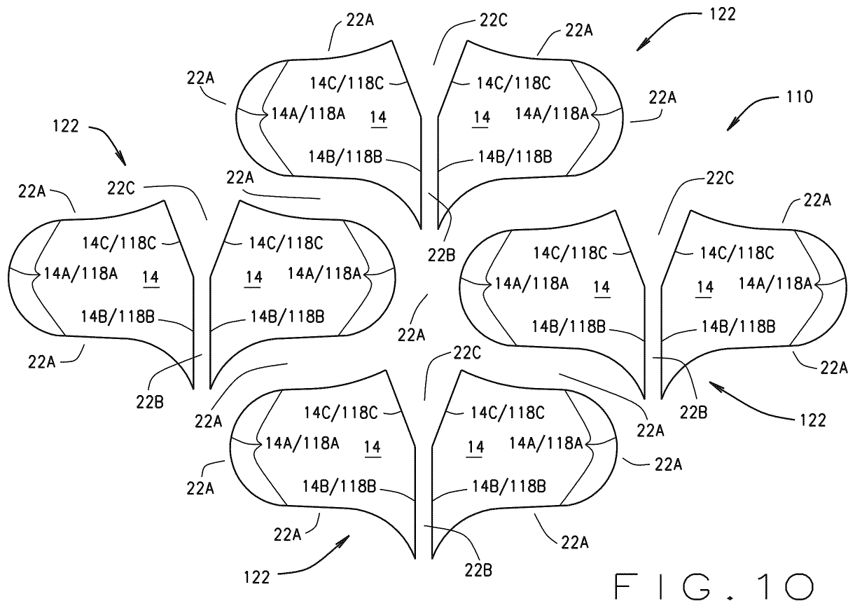

Generally, the system 10 provides an inertial microfluidic filtration technology that integrates active and passive components to regulate secondary flow development. As described in detail below, elastomeric bi-stable microstructures 14 (FIGS. 6, 7, 8, 9 and 10) of a microfluidic object isolation device 18 (FIGS. 1, 4, 5 and 6) through which a fluidic medium (e.g., a biological sample, e.g., a blood sample) can be passed are temporarily compressed to generate secondary flow vortices within the fluidic medium flowing through fluid flow microchannels 22 (FIGS. 6, 7, 8, 9 and 10) formed between the microstructures 14. The secondary flow vortices separate the smaller microscale objects from the larger microscale objects and the separated larger microscale objects are captured within fluid flow microchannels 22. Thereafter, the microstructures 14 are decompressed to their initial state, whereby the secondary flow vortices are supressed, and the captured larger microscale objects are released and collected for analysis. The elastomeric bi-stable microstructures 14 can be fabricated from suitable elastomeric or hyper-elastic material such as Spolydimethylsiloxane (PDMS) silicone elastomers (e.g., Sylgard™-184), silicone rubbers (e.g., Elastosil®-M4130), and flexible thermoplastics (e.g., Flexdym™).

The microscale object isolation system 10 generally comprises a load transmission assembly press 26, a load transmission assembly 30 removably disposable and/or mountable to the load transmission assembly press 26, and the microfluidic object isolation device 18 that is removably disposable in the load transmission assembly 30. The load transmission assembly press 26 generally comprises a top platen 38, a compression platen 42, a base platen 46 and a compression load assembly 50 that is structured and operable to controllably move the compression platen up and down (i.e., in the X⁻ and X⁺ directions) between the top platen 38 and the bottom platen 46. More particularly, the top platen 38 is fixedly connected with the bottom platen via a plurality of guide rods 54, and the compression platen 42 is slidably mounted to the guide rods 54 such that the compression platen 42 can be controllably moved up and down in the X⁻ and X⁺ directions as controlled by the compression load assembly 50. The compression load assembly 50 generally comprises a load actuator 58 that is mechanically and operatively connected to a load sensor 62 that is fixedly mounted to compression platen 42. The load actuator 58 can be any electrical, pneumatic, hydraulic, manual or other device that is structured and operable to controllably move the compression platen 42 up and down in the X⁻ and X⁺ directions to apply a desired load or force in the X⁻ direction to the load transmission assembly 30. For example, in various embodiments, the load actuator 58 can comprise a linear stepper motor that is mechanically and operatively connected to the load sensor 62 via threaded rod, whereby the stepper motor operatively engages the threaded rod to move the threaded rod, and hence the load sensor 62 and the compression platen 42 up and down in the X⁻ and X⁺ directions to apply a desired load or force in the X⁻ direction to the load transmission assembly 30.

Operation of the load actuator 58 is controlled by a controller (not shown) to move the load sensor 62 and hence the compression platen 42 up and down in the X⁻ and X⁺ directions. Particularly, the controller controls operation of the load actuator 58 moves the load sensor 62 and hence the compression platen 42 down in the X⁻ direction to apply a controlled amount of load of force in the X⁻ direction to the load transmission assembly 30, as described below. The controller for the load actuator 58 can be any device or mechanism, such as a computer-based controller, and electrical On/Off switch, a manual crank, know or handle, etc., that is suitable to controllably operate the load actuator 58 to move the compression platen 42 up and down in the X⁻ and X⁺ directions, and apply a desired load or force in the X⁻ direction to the load transmission assembly 30. The load sensor 62 is structured and operable to sense the load being applied by the load transmission assembly 30 by the load actuator 58 and compression platen 42 and communicate the sensed load to an operator of the system 10 via a display read-out or data sent to a computer-based controller of the load actuator 58.

The load transmission assembly 30 generally comprises a bottom panel 70, a top panel 74 movably mounted to the bottom panel 70 via a plurality of guide shafts 78, and a plurality of locking mechanisms 82. The top panel 74 is slidably mounted to the guide shafts 78 such that the top panel 74 can be controllably moved up and down in the X⁻ and X⁺ directions. The load transmission assembly 30 is removably disposable and/or mountable on and/or to the base platen 46 of the load transmission assembly press 26 between the top platen 38 and the base platen 46. In various embodiments, the base platen 46 of the load transmission assembly press 26 can comprise a plurality of locating pin 66 that are structured and operable to accurately position and retain the microfluidic object isolation device 18 in a desired location between the base platen 46 and the compression platen 42. The load transmission assembly 30 is structured and operable to receive the microfluidic object isolation device 18 between the top panel 74 and the bottom panel 70. Moreover, the load transmission assembly 30 is structured and operable to receive the microfluidic object isolation device 18 in a static state (i.e., an uncompressed state), compress at least portion of the microfluidic object isolation device 18 to a compressed state via controlled operation of the load transmission assembly press 26, and controllably lock in a Closed position wherein the microfluidic object isolation device 18 is securely retained therein and maintained in the compressed state.

The locking mechanisms 82 are structured and operable to lock the load transmission assembly 30 in the Closed position wherein the microfluidic object isolation device 18 is securely retained therein and maintained in the compressed state. The locking mechanisms 82 can be any locking mechanism suitable for controllably securing the top panel 74 of the load transmission assembly 30 in a lowered/compressed position after the load transmission assembly press 26 has compressed the microfluidic object isolation device 18 between the top and bottom panels 74 and 10. For example, in various instances, the locking mechanisms can be twisting expansion device, wherein a circumference of the locking mechanisms 82 expands within a locking mechanism hole 84 formed within the load transmission assembly top panel 74, thereby retaining the lowered/compressed position, such that the microfluidic object isolation device 18 is retained in the compressed state. In various embodiments, the top plate 74 can comprise a transparent window 86 that allows visual observation of the microfluidic object isolation device 18 when the microfluidic object isolation device 18 is retained within the load transmission assembly 30. Additionally, in various embodiments the load transmission assembly 30 can comprise a compression target region block 90 extending and protruding from an underside of the top panel 74 toward bottom panel 70 such that the compression target region block 90 is disposed between and extends into the space between the top panel 74 and the bottom panel 70. As described further below, the compression target region block 90 is structured and operable to apply a load or compression force to a target region of the microfluidic object isolation device 18 when the microfluidic object isolation device 18 locked within the load transmission assembly 30 in the compressed state.

Referring now to FIGS. 1, 4, 5, 6 and 7, the microfluidic object isolation device 18 generally comprises a top plate 94, a bottom plate 98, and at least one elastomeric perimeter wall 102 disposed between the top and bottom plates 94 and 98 and around a perimeter of the top and bottom plates 94 and 98, thereby defining an interior chamber 106. The microfluidic object isolation device 18 further comprises an array 110 of the elastomeric bi-stable microstructures 14 formed between the top and bottom plates 94 and 98 within the interior chamber 106. The components of the microfluidic isolation device 18 (e.g., the top plate 94, the bottom plate 98, and the at least one elastomeric perimeter wall 102 and the array 110 of the elastomeric bi-stable microstructures 14) can be formed/manufactured/produced independently and assembled to produce the microfluidic object isolation device 18, or any 2 or more of them can be integrally formed/manufactured/produced together to produce the microfluidic object isolation device 18. For example, in various embodiments, the top plate 94, the at least one elastomeric perimeter wall 102 and the array 110 of the elastomeric bi-stable microstructures 14 can be integrally formed/manufactured/produced (e.g., 3D printed via any suitable additive manufacturing method) as a single structure. As described above, the elastomeric bi-stable microstructures 14 are spaced apart such that the fluid flow microchannels 22 are defined between adjacent elastomeric microstructures 14, wherein the fluid flow microchannels 22 comprise a plurality of object bypass zones 22A, a plurality of object capture zones 22B, and a plurality of capture inlet zones 22C. The microfluidic object isolation device 18 additionally comprises an ingress port 114 structured and operable to ingress a fluidic medium into the interior chamber 106 and an egress port 116 structured and operable to egress the fluidic medium from the interior chamber 106. The ingress and egress ports 114 and 116 are respectively connectable to any suitable fluidic medium input and output devices such as a syringe, flexible tubing (e.g., sterile tubing, rigid tubing, etc.), whereby the fluidic medium can be input into (e.g., injected into) the microfluidic object isolation device 18 interior chamber 106, flow through the array 110 of elastomeric bi-stable microstructures 14 and subsequently output from the microfluidic object isolation device 18.

In operation the compression load assembly 50 is structured and operable to controllably move the compression platen up and down (i.e., in the X⁻ and X⁺ directions) between the top platen 38 and the bottom platen 46 to compress the load transmission device 30 such that the microfluidic object isolation device 18 is compressed from the static state to a capture state whereby the elastomeric bi-stable microstructures 14 are compressed. Compression of the elastomeric bi-stable microstructures 14 alters the fluid flow microchannels 22 from a static shape and size to a capture shape and size, whereby the larger microscale objects (LMOs) within a fluidic medium flowing through the microfluidic object isolation device 18 are captured within the object capture zones 22B. Specifically, the array 110 of elastomeric bi-stable microstructures 14 are structured and arranged such that compression of the microstructures 14 will selectively direct the larger microscale objects (LMOs) toward the object capture zones 22B of the fluid flow microchannels 22 and the smaller microscale objects (SMOs) into object bypass zones 22A of the fluid flow microchannels 22. Subsequently, the captured larger microscale objects can be flushed from the array 110 of elastomeric bi-stable microstructures 14 and from the interior chamber 106 by inputting (e.g., injecting) a flushing fluid into the microfluidic object isolation device 18 interior chamber 106, whereby the captured larger microscale objects can be removed and collected via the egress port 116.

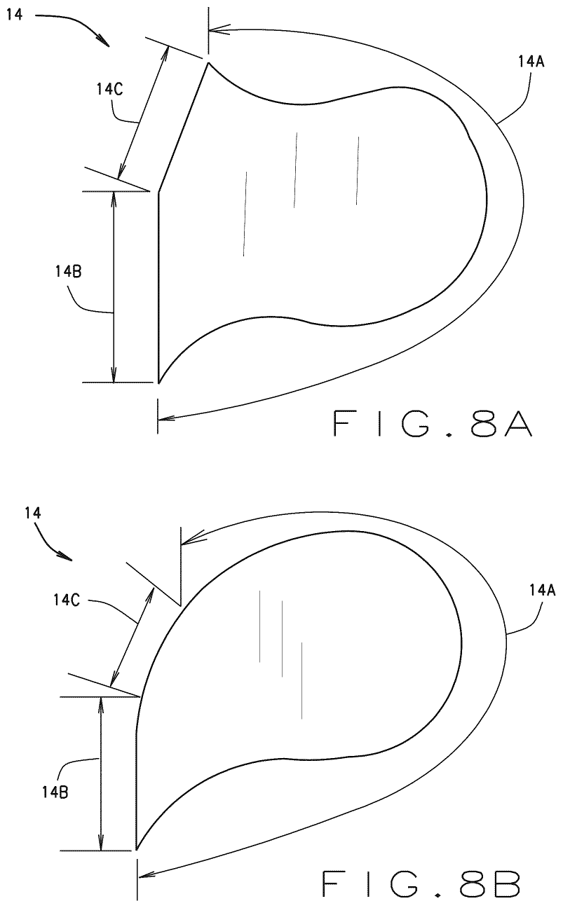

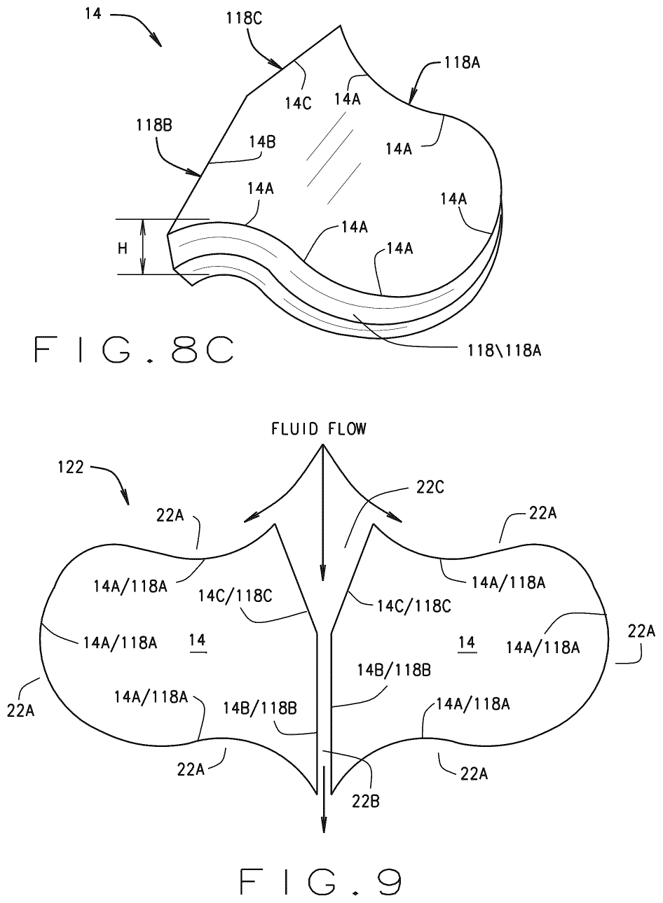

Referring now to FIGS. 8A, 8B, 8C, 9 and 10, FIGS. 8A and 8B provide alternative exemplary top views of an elastomeric bi-stable microstructures 14 in the array 110, in accordance with various embodiments of the present disclosure. FIGS. 8A and 8B can also be described herein as providing alternative exemplary lateral cross-sectional planar views of an elastomeric bi-stable microstructure 14 that is substantially parallel to the top and bottom plates 94 and 98 of the microfluidic object isolation device 18. Notably, the top view perimeter shapes, or lateral cross-sectional planar perimeter shapes, of the elastomeric bi-stable microstructures 14 illustrated in FIGS. 8A and 8B and throughout the various other figures described herein are exemplary only. The perimeter shape of the elastomeric bi-stable microstructures 14 of the present disclosure can be any shape that satisfies the following description. As exemplarily illustrated in FIGS. 8A, 8B and 8C, each elastomeric bi-stable microstructure 14 is a structure having a perimeter wall 118 having a static state height H (e.g., 65 μm) (FIG. 8C) and a top view perimeter shape, or a lateral cross-sectional planar perimeter shape, comprising a curved bypass portion 14A, an object capture portion 14B, and a capture inlet portion 14C (FIGS. 8A and 8B). Accordingly, the perimeter wall 118 comprises a curved bypass section 118A that corresponds to, extends from and has the same length as the perimeter shape curved bypass portion 14A, an object capture section 118B that corresponds to, extends from and has the same length as the perimeter shape object capture portion 14B, and a capture inlet section 118C that corresponds to, extends from and has the same length as the perimeter shape capture inlet portion 14C.

As described above, the perimeter shape of the elastomeric bi-stable microstructures 14 of the present disclosure can be any shape that satisfies the description above. For example, as exemplarily illustrated in FIGS. 6, 7, 8A, 80, 9 and 10, in various embodiments, the curved bypass portion 14A of the perimeter shape of the top view, or the lateral cross-sectional plane view, of each elastomeric microstructure 14 can comprise a curved bell-shaped dome portion. Additionally, in such embodiments the object capture portion 14B can comprise a straight capture segment of a bifurcated base portion from which the curved bell-shaped dome portion extends, and the capture inlet portion 14C can comprises a straight capture inlet segment of the bifurcated base portion extending at an angle from the straight capture segment. Accordingly, in such embodiments, the perimeter wall 118 of each elastomeric microstructure comprises a curved bell-shaped dome bypass section, a straight object capture section and a straight capture inlet section.

As exemplarily illustrated in FIGS. 6, 7, 9 and 10, the array 110 of elastomeric bi-stable microstructures 14 comprises a plurality of elastomeric microstructure pairs 122 comprising a mirror-imaged pair of elastomeric microstructures 14. More particularly, the pair (i.e., two) of elastomeric bi-stable microstructures 14 in each elastomeric microstructure pair 122 are arranged, aligned, and oriented to be mirror images of each other such thar the capture sections 118B of the perimeter walls 118 of the pair 122 of elastomeric bi-stable microstructures 14 are substantially parallel and define the object capture zones 22B of the fluid flow microchannels 22. Additionally, the inlet sections 118C of the perimeter walls 118 of the pair 122 of elastomeric bi-stable microstructures 14 define the capture inlet zone 22C of the fluid flow microchannels 22. Furthermore, the curved bypass sections 118A of the perimeter walls 118 of each pair 122 of elastomeric bi-stable microstructures 14 define the object bypass zones 22A of the fluid flow microchannels 22 disposed between the curved bypass sections 118A of the perimeter walls 118 of the elastomeric bi-stable microstructures 14 of adjacent pairs 122 of elastomeric bi-stable microstructures 14.

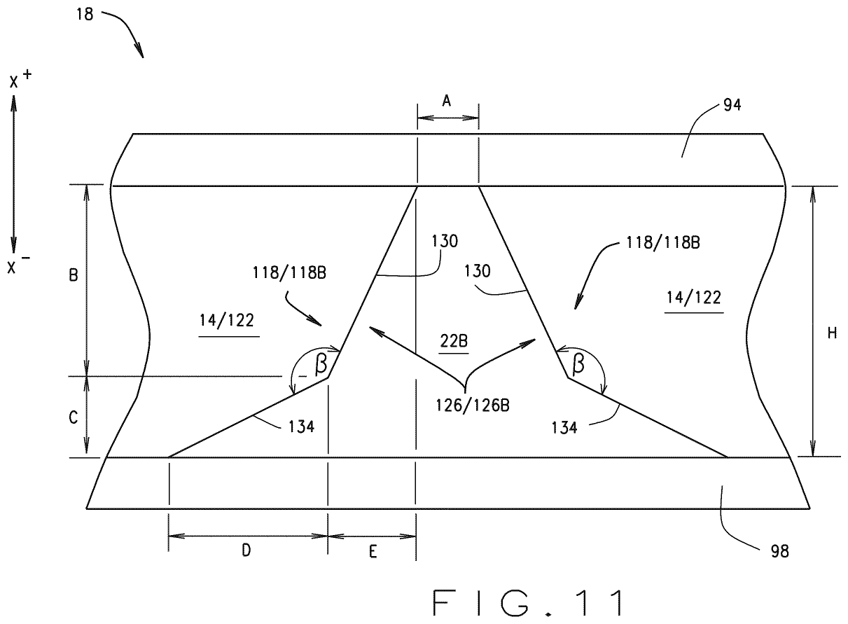

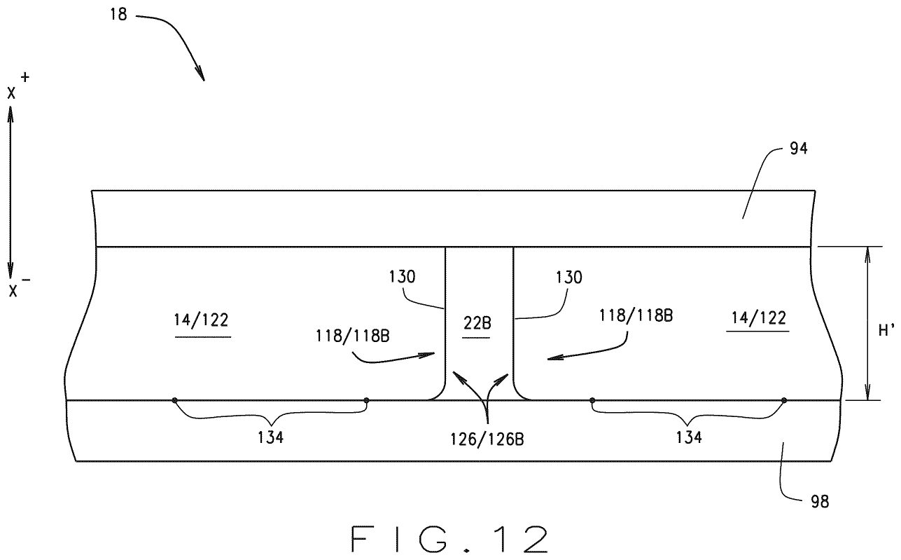

Referring now to FIGS. 11 and 12, in light of the various figures and description here, one skilled in the art will readily understand that the fluid flow microchannels 22 comprise a pair of opposing sidewalls 126 that are defined by and comprise the perimeter walls 118 of adjacent elastomeric bi-stable microstructures 14. Accordingly, not specifically illustrated but readily understood by one skilled in the art, the portion the microchannel opposing sidewalls 126 that border the fluid flow channel object bypass zones 22A and are defined by and comprise the perimeter wall curved bypass sections 118A of adjacent elastomeric bi-stable microstructures 14 will be referred to herein as the microchannel bypass zone opposing sidewalls 126A. Similarly, the portion the microchannel opposing sidewalls 126 that boarder the fluid flow channel object capture zones 22B and are defined by and comprise the perimeter wall capture sections 118B of adjacent elastomeric bi-stable microstructures 14 will be referred to herein as the microchannel capture zone opposing sidewalls 126B. As follows, the portion the microchannel opposing sidewalls 126 that boarder the fluid flow channel capture inlet zones 22C and are defined by and comprise the perimeter wall capture inlet sections 118C of adjacent elastomeric bi-stable microstructures 14 will be referred to herein as the microchannel capture inlet zone opposing sidewalls 126C.

FIG. 11 provides a cross-sectional view of a portion of the microfluidic object isolation device 18, wherein a portion of a pair 122 of the array 110 of adjacent elastomeric bi-stable microstructures 14 are shown exemplarily illustrating the cross-sectional shape of the object capture zone 22B of the fluid flow microchannels 22 as formed by the perimeter wall object capture sections 118B of the adjacent elastomeric bi-stable microstructures 14, in accordance with various embodiments of the present disclosure. The elastomeric bi-stable microstructures 14 are referred to herein as bi-stable namely because at least the microchannel capture zone opposing sidewalls 126B (i.e., the object capture sections 118B of the perimeter walls 118 of elastomeric bi-stable microstructures 14) have a bi-stable shape and geometry such that when the microfluidic object isolation device 18 is in the static state, more specifically when the elastomeric bi-stable microstructures 14 are uncompressed, the microchannel object capture zones 22B have a first geometrical shape and size (FIG. 11) designed to allow the smaller and the larger microscale objects to pass therethrough. However, when the microfluidic object isolation device 18 is in the compressed capture state, more specifically when the elastomeric bi-stable microstructures 14 are compressed, the microchannel object capture zones 22B have a second geometrical shape and size (FIG. 12) designed to capture the larger microscale objects.

It should be noted that although the bi-stable shape and geometry of the microchannel sidewalls 126 (i.e., the perimeter walls 118 of elastomeric bi-stable microstructures 14) will be exemplarily described and illustrated herein with regard to the microchannel capture zone opposing sidewalls 126B (i.e., the object capture sections 118B of the perimeter walls 118 of elastomeric bi-stable microstructures 14), in various embodiments, such description and illustrations can further be applicable to the microchannel bypass zone opposing sidewalls 126A (i.e., the bypass sections 118A of the perimeter walls 118 of elastomeric bi-stable microstructures 14) and the microchannel capture inlet zone opposing sidewalls 126C (i.e., the object capture inlets sections 118C of the perimeter walls 118 of elastomeric bi-stable microstructures 14). For example, in various embodiments at least the microchannel capture zone opposing sidewalls 126B (i.e., the object capture sections 118B of the perimeter walls 118 of elastomeric bi-stable microstructures 14) of the microchannel opposing sidewalls 126 have a bi-stable shape and geometry comprising a slanted upper section 130 and undercut lower section 134 extending at an angle β from the slanted upper section 130. As illustrated in FIG. 11, the fluid flow microchannel opposing sidewalls 126 (e.g., microchannel capture zone opposing sidewalls 126B) are uncompressed when the microfluidic object isolation device 18, the elastomeric bi-stable microstructures 14 and the microchannels 22 are in the static state. Particularly, when in the static state, the microchannel object capture zones 22B have the first geometrical shape and size designed to allow the smaller and the larger microscale objects to pass therethrough. Moreover, when in the static state, the shape and size of the microchannels 22 (e.g., the object capture zones 22B) comprise the uncompressed opposing sidewalls s 122 (e.g., the uncompressed object capture zone sidewalls 122B), defined by the adjacent uncompressed elastomeric microstructure perimeter walls 118 (e.g., the uncompressed object capture zone perimeter walls 118B) having slanted upper sections 130 and undercut lower sections 134 having a concave-triangle shape such that the large microscale objects can pass therethrough.

As illustrated in FIG. 12, the microfluidic object isolation device 18, the elastomeric bi-stable microstructures 14 and the fluid flow microchannel opposing sidewalls 126 (e.g., microchannel capture zone opposing sidewalls 126B) are compressed, via the load transmission assembly press 26, when the microfluidic object isolation device 18, the elastomeric bi-stable microstructures 14 and the microchannels 22 are in the capture state. Particularly, when in the capture state, the microchannel object capture zones 22B have the second geometrical shape and size designed to capture the larger microscale objects. Moreover, when in the capture state, the shape and size of the fluid flow microchannels 22 (e.g., the object capture zones 22B) comprise the compressed opposing sidewalls 122, defined by the adjacent compressed elastomeric microstructure perimeter walls 118 (e.g., the compressed object capture zone perimeter walls 118B) slanted upper sections 130 and undercut lower sections 134, having a generally rectangular shape throughout substantially an entire height H′ (e.g., 35 μm) of the compressed fluid flow microchannels 22 (e.g., the object capture zones 22B) such that the large microscale objects are separated from the small microscale objects in the bypass zones 22A and the large microscale objects are directed into and captured in the object capture zones 22B.

Although the bi-stable shape and geometry of the microchannel sidewalls 126 have been exemplarily described above to define the microchannels 22 (e.g., the capture zones 22B of the microchannels 22) as having a concave-triangle shape, it is envisioned that the bi-stable shape and geometry of the microchannel sidewalls 126 can be any shape and geometry suitable such that the cross-sectional shape and geometry of the microchannels 22 will transition from the uncompressed static state having a first geometrical shape and size to compressed state having a second geometrical shape and size that will produce the secondary flows that will separate the larger microscale objects from the smaller microscale objects, and will transform the cross-sectional shape, geometry and size of the microchannel capture zones 22B to capture/isolate the larger microscale objects as described herein. Additionally, it is envisioned that different zones of the microchannels 22 described herein (e.g., the bypass zones 22A, the object capture zones 22B and the capture inlet zones 22C) can have different cross-sectional shapes, geometries and sized in order to enhance the production of the secondary flows that will separate the larger microscale objects from the smaller microscale objects, and will transform the cross-sectional shape, geometry and size of the microchannel capture zones 22B to enhance the capture/isolation of the larger microscale objects as described herein.

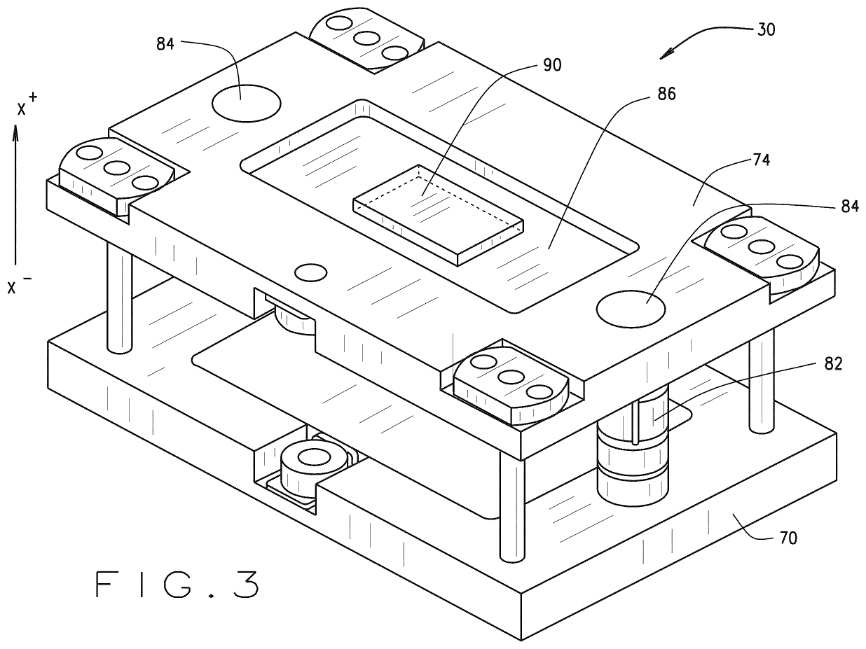

Referring now to FIGS. 3, 4, 5, 11 and 12, as described above the microfluidic object isolation device 18 that is removably disposable in the load transmission assembly 30, and the load transmission assembly 30 is removably disposable and/or mountable to the load transmission assembly press 26. Moreover, the load transmission assembly 30 is structured and operable to receive the microfluidic object isolation device 18 in the static state (i.e., an uncompressed state) and subsequently be disposed on the base platen 46 of the load transmission assembly press 26. Thereafter, via controlled operation of the compression load assembly 50, the compression platen 42 of the load transmission assembly press 26 is lowered in the X⁻ direction to contact the top panel 74 of the load transmission assembly 30 to thereby controllably lower the load transmission assembly top panel 74 in the X⁻ direction into contact with the top plate 94 of the microfluidic object isolation device 18. Thereafter, further downward movement or pressure of the load transmission assembly top panel 74 will compress the microfluidic object isolation device 18, and more specifically compress the elastomeric bi-stable microstructures 14 of the microfluidic object isolation device 18. The load sensor 50 measures the amount of load or pressure that is being applied to the microfluidic object isolation device top panel 74 and thereby controls the amount of pressure applied to the microfluidic object isolation device 18, the distance the microfluidic object isolation device top plate 94 is pushed downward in the X⁻ direction, and hence the amount the elastomeric bi-stable microstructures 14 are compressed. Specifically, the load sensor 50 controls the amount of pressure applied to the microfluidic object isolation device 18 such that the microfluidic object isolation device 18 is transitioned (i.e., compressed) from the static state to the compressed state. Moreover, such that the array 110 of the elastomeric bi-stable microstructures 14 are transitioned (i.e., compressed) from the static state to the compressed state. And still further, such that the fluid flow microchannels 22 (e.g., the microchannel capture zones 22A) are transitioned (i.e., compressed) from the static state having the first geometrical shape and size to the compressed state having the second geometrical shape and size as described above.

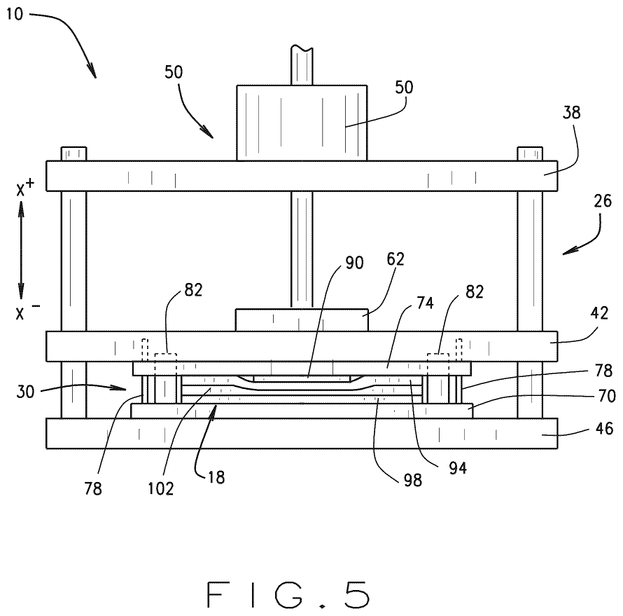

More particularly, in various embodiments, the top panel 74 of the load transmission assembly 30 is pushed downward in the X⁻ direction, via the controlled downward movement of the load transmission assembly press compression platen 42, to controllably press the compression target region block 90 mounted to the underside of the load transmission assembly top panel 74 into contact with the top plate 94 of the microfluidic object isolation device 18. Thereafter, further downward movement or pressure of the load transmission assembly top panel 74 and the compression target region block 90 to compresses a target region of the microfluidic object isolation device 18 (shown in FIG. 5), and more specifically compresses a target region of the array 110 elastomeric bi-stable microstructures 14 of the microfluidic object isolation device 18. The target region of the elastomeric bi-stable microstructures 14 can comprise some or all of the elastomeric bi-stable microstructures 14 of the microfluidic object isolation device 18. As described above, the load sensor 50 measures the amount of load or pressure that is being applied to the microfluidic object isolation device top panel 74. More particularly, in such embodiment the load sensor 50 measures and controls the amount of pressure applied to the target region of microfluidic object isolation device 18, the distance the target region of the microfluidic object isolation device top plate 94 is pushed downward in the X⁻ direction, and hence the target region of the array 110 elastomeric bi-stable microstructures 14 is compressed. Specifically, the load sensor 50 controls the amount of pressure applied to the target region of the microfluidic object isolation device 18 such that the microfluidic object isolation device 18 is transitioned (i.e., compressed) from the static state to the compressed state. Moreover, such that the target region of the array 110 of the elastomeric bi-stable microstructures 14 is transitioned (i.e., compressed) from the static state to the compressed state. And still further, such that the fluid flow microchannels 22 within the target region of the array 110 (e.g., the microchannel capture zones 22A within the target region of the array 110) are transitioned (i.e., compressed) from the static state having the first geometrical shape and size to the compressed state having the second geometrical shape and size as described above.

Once the microfluidic object isolation device 18 (e.g., the target region of the microfluidic object isolation device 18) has been transitioned/compressed a predetermined to the compressed state, more particularly, once elastomeric bi-stable microstructures 14 (e.g., the target region of the array 110 of the elastomeric bi-stable microstructures 14) have been transitioned/compressed to the compressed state, and still more particularly, once the fluid flow microchannels 22 (e.g., the microchannel capture zones 22B of the array 110 elastomeric bi-stable microstructures 14) have been transitioned/compressed to the compressed state having the second geometrical shape and size, the load transmission assembly 30 can be controllably locked in the Closed position via operation of the locking mechanisms 82. When the load transmission assembly 30 is locked in the Closed position, the microfluidic object isolation device 18 securely retained therein and maintained in the compressed state. In various embodiments, once the load transmission assembly 30 is locked in the Closed position, thereby retaining the microfluidic object isolation device 18 in the compressed state, the fluid medium can be introduced (e.g., injected, pumped or gravity fed) into the microfluidic object isolation device 18 via the ingress port 114. Subsequently, the fluid medium will flow through the array 110 of elastomeric bi-stable microstructures, whereby the array 110 of pairs 122 of elastomeric bi-stable microstructures 14, will generate secondary flows within the fluid medium flowing through the microfluidic object isolation device 18 that will separate the larger microscale objects from the smaller microscale objects and capture the larger microscale objects within the compressed object capture zones 22B of the microchannels 22 as described further below. The fluid medium can be forced through the microfluidic object isolation device 18 via injection, pumping, etc., or the fluid medium can naturally flow through the microfluidic object isolation device 18 via gravitational force.

After the fluid medium has been processed by the microfluidic object isolation device 18 (i.e., the fluid medium passed through the microfluidic object isolation device 18 via forced flow or natural flow), and the larger microscale objects have been captured (i.e., isolated from the smaller microscale objects), the microfluidic object isolation device 18 can be allowed to return to the static state, via operation of the locking mechanisms 82, whereby the elastomeric bi-stable microstructures 14 decompress to return the microchannel object capture zones 22B to the static state having the first geometrical shape and size (e.g., the concave triangle shape), whereafter the larger microscale objects are released and can be egressed through the egress port. Particularly, the larger microscale objects can be flushed from the microchannel capture zones 22B and from the microfluidic object isolation device 18 by introducing a flushing fluid into the microfluidic object isolation device 18 ingress port 110, via forced flow or natural flow.

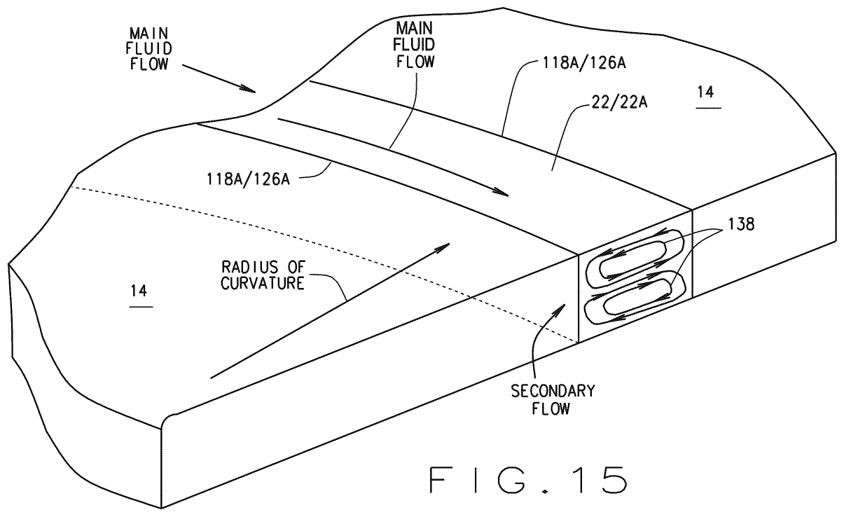

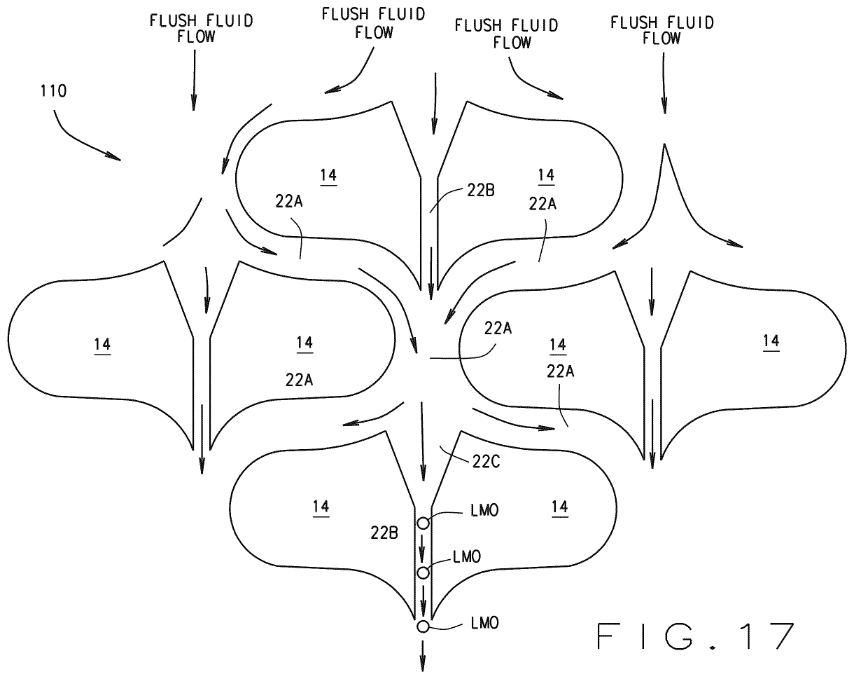

Referring now to FIGS. 1 through 17, as described above, when the microfluidic object isolation device 18 is compressed, thereby compressing the elastomeric bi-stable microstructures 14 (e.g. the array 110 of pairs 122 of elastomeric bi-stable microstructures 14) to the compressed state, the microchannels 22 are transitioned from the first geometrical shape and size to the second geometrical shape and size. Notably, the microchannel opposing sidewalls 126B of the microchannel object capture zones 22B comprise the slated upper section 130 and the undercut lower section 134 such that the first geometrical shape of the microchannel object capture zones 22B is the concave triangular shape, as described above. However, the microchannel opposing sidewalls 126A and/or 126C of the microchannel object bypass zones 22A and/or capture inlet zones 22C can have the same or different geometries than the microchannel opposing sidewalls 126B of the microchannel object capture zones 22B such that the first geometrical shape of the microchannel object bypass zones 22A and/or capture inlet zones 22C can have the concave triangular shape or any other shape suitable for generating the secondary flows when transitioned to the compressed state. Importantly, the first size of the microchannel object bypass zones 22A and the capture inlet zones 22C is greater in width than the microchannel object capture zones 22B such that when the microchannels 22 are transitioned to the compressed state the width of the compressed microchannel object bypass zones 22A and the capture inlet zones 22C is larger than a diameter of the largest larger microscale object. Conversely, the first size of the microchannel object capture zones 22B is such that when the microchannels 22 are transitioned to the compressed state the width of the compressed microchannel object capture zones 22B is smaller than a diameter of the smallest larger microscale object. Additionally, in various embodiments when the microchannels 22 are transitioned to the compressed state the width of the compressed microchannel object capture zones 22B is also larger than a diameter of the largest smaller microscale object.

For example, as exemplarily illustrated in FIG. 11, when the cross-sectional geometry of any zone of the microchannel 22 (e.g., the object bypass zone 22A, the object capture zone 22B and/or the object inlet zone 22C) has the concave triangular shape and the microfluidic object isolation device 18 and the elastomeric bi-stable microstructures 14 are in the uncompressed static state having the height H (e.g., 65 μm), in various embodiments, a gap A between adjacent elastomeric bi-stable microstructures 14 must be greater than or equal a desired width of the respective microchannel zone (e.g., the object bypass zone 22A, the object capture zone 22B or the object inlet zone 22C) when the microfluidic object isolation device 18 and the elastomeric bi-stable microstructures 14 are in the compressed state. Additionally, a height B of the slanted upper section 130 of the microchannel sidewall 126 must be greater than or equal the height H′ (e.g., 35 μm) of the elastomeric bi-stable microstructures 14 when the microfluidic object isolation device 18 and the elastomeric bi-stable microstructures 14 are in the compressed state. Furthermore, a height C of the undercut lower section 134 of the microchannel sidewall 126 must be less than or equal to a width D of the undercut lower section 134 of the microchannel sidewall 126. Finally, the width D of the undercut lower section 134 of the microchannel sidewall 126 must be greater than or equal to a width E of the slanted upper section 130 of the microchannel sidewall 126.

As described in detail below, when the array 110 of pairs 122 of elastomeric bi-stable microstructures 14 are compressed to the compressed state, the microchannels 22 are transitioned from the first geometrical shape and size to the second geometrical shape and size, the smaller microscale objects will be directed into and flow through the object bypass zones 22A and subsequently exit or egress the microfluidic object isolation device 18, while the larger microscale objects will directed into and flow through the capture inlet zones 22C which directs the larger microscale objects into the object capture zones 22B where the larger microscale objects are captured and isolated from the smaller microscale objects. More specifically, when the microfluidic object isolation device 18 is compressed and retained in compressed state such that the array 110 of pairs 122 of elastomeric bi-stable microstructures 14 are compressed and retained in the compressed state, and a fluid medium is introduced into the microfluidic object isolation device 18, the second geometrical shape and size of the compressed microchannel object bypass zones 22A will modulate a Reynolds number (Re) within a fluid flow of the fluidic medium flowing through the microchannels 22, sometimes referred to herein as the main fluid flow.

The Reynolds number for a channel is given as follows:

$${R}_{e} = \frac{{D}_{h} \cdot {V}_{avg} \cdot ρ}{μ} , \qquad ( 1 )$$

wherein Dh=hydraulic diameter, Vavg=average fluid velocity, ρ=fluid density, and μ=fluid viscosity. The hydraulic diameter for a channel cross-section is given as follows:

$${D}_{h} = \frac{4 A}{p} , \qquad ( 2 )$$

wherein A=cross-sectional area of flow passage, and p=wetted perimeter of microchannel cross-section. Hence, when the array 110 of pairs 122 of elastomeric bi-stable microstructures 14 are compressed (i.e., in the compressed state) the cross-sectional area of the microchannels 22 decreases, the velocity of the main fluid flow increases and the value of the Reynolds number Re increases. Conversely, when the array 110 of pairs 122 of elastomeric bi-stable microstructures 14 are decompressed (i.e., in the static state) the cross-sectional area of the microchannels 22 increases, the velocity of the main fluid flow decreases and the value of the Reynolds number Re decreases.

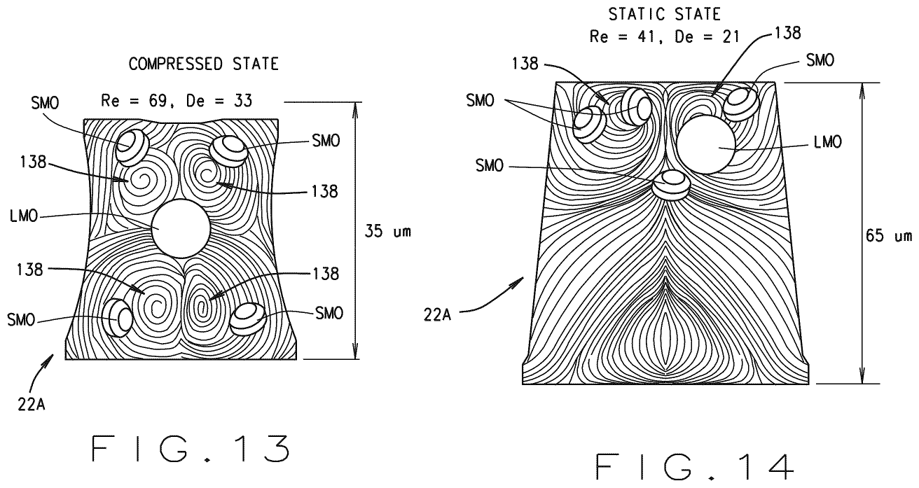

Moreover, as exemplarily illustrated in FIGS. 13, 14, 15 and 16, when the microfluidic object isolation device 18 is compressed and retained in the compressed state such that the array 110 of pairs 122 of elastomeric bi-stable microstructures 14 are compressed and retained in the compressed state, the cross-sectional area of the microchannels 22 is reduced and transitioned to the second geometrical shape and size. Consequently, when the fluid medium, e.g., (a blood sample) is introduced into the microfluidic object isolation device 18 and the main fluid flow (i.e., the flow of the fluid medium) passes through the curved object bypass zones 22A of the microchannels 22, the second geometrical shape and size of the compressed microchannel object bypass zones 22A will increase a Dean number (De) within the main fluid flow, thereby creating a secondary flow perpendicular to the main fluid flow. The secondary flow will comprise counter-rotating secondary flow vortices 138. The Deans number (De) is related to the Reynolds number (Re) as follows:

$${D}_{e} = {R}_{e} \sqrt{\frac{{D}_{h}}{2 R}} , \qquad ( 3 )$$

wherein, Dₕ=hydraulic diameter, R=radius of curvature, V_{avg}=average fluid velocity, ρ=fluid density and μ=fluid viscosity.

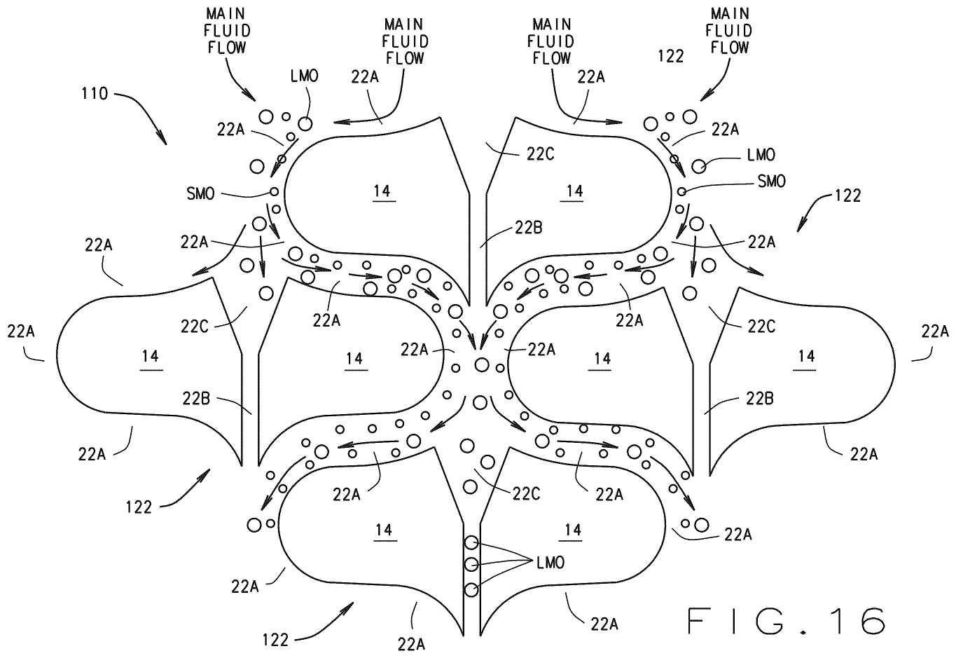

The secondary flow vortices 138 will separate the larger microscale objects (e.g., CTCs) from the smaller microscale objects (e.g., RBCs). The secondary flow vortices 138 are counter-rotating helical streamlines moving perpendicular in direction to the main flow in the curved microchannel object bypass zones 22A. As exemplarily illustrated in FIGS. 13 and 16, the secondary flow vortices 138 in combination with the curvature of the object bypass zones 22A of the microchannels 22 will cause the smaller microscale objects to gravitate or migrate to the microchannel bypass zone opposing sidewalls 126A, follow the curvature of the of the object bypass zones 22A of the microchannels 22, and remain with the portion of the main fluid flow (i.e., the flow of the fluid medium) that will flow within the microchannel object bypass zones 22A throughout the array 110 of pairs 122 of elastomeric bi-stable microstructures 14, as described further below. Hence, the smaller microscale objects will remain within and continue to move within the object bypass zones 22A, thereby bypassing the capture inlet zones 22C and the object capture zones 22B.

Moreover, as exemplarily illustrated in FIGS. 13 and 16, the secondary flow vortices 138 in combination with the curvature of the object bypass zones 22A of the microchannels 22 will separate/isolate the larger microscale objects from the smaller microscale objects and force the larger microscale objects away from the microchannel bypass zone opposing sidewalls 126A, such that the larger microscale objects will remain with the portion of the main fluid flow (i.e., the flow of the fluidic medium) that flows into the microchannel capture inlet zones 22C and through the object capture zones 22B throughout the array 110 of pairs 122 of elastomeric bi-stable microstructures 14, as described further below. Notably, since the main fluid flow (i.e., the flow of fluidic medium) is flowing through the array 110 of pairs 122 of elastomeric bi-stable microstructures 14 in the compressed state wherein the cross-sectional area of the microchannels 22 defining the object capture zones 22B is smaller than in the uncompressed static state, and the cross-sectional geometry of the microchannel object capture zones 22B has been transitioned from the first geometrical shape and size (e.g., the concave triangle) to the second geometrical shape and size (e.g., the substantially rectangular shape), the larger microscale object directed into the microchannel capture zones 22B will be captured within the microchannel capture zones 22B and will not exit or egress the microfluidic object isolation device 18 as will the remainder of the fluidic medium and smaller microscale objects. In FIGS. 13, 14 and 16 the larger microscale objects are identified as LMO and the smaller microscale objects are identified as SMO.

More specifically, when the microfluidic object isolation device 18, hence the elastomeric bi-stable microstructures 14, and hence the microchannels 22 are in the uncompressed static state, the main fluid flow flowing through the microchannels 22 has the characteristic of a Poiseuille flow, which describes a parabolic flow profile of the laminar flow of the main fluid flow flowing within the microchannels 22. Typically, a laminar flow, such as the main fluid flow flowing through the microchannels 22 in the uncompressed static state, has a Reynolds number (Re) of less than 2000. As illustrated in FIG. 14, generally, if/when a fluidic medium (e.g., a blood sample) is introduced into the microfluidic object isolation device 18 when the microfluidic object isolation device 18 is in the uncompressed static state such that the microchannels 22 are in the uncompressed static state having the first geometrical shape and size, both the smaller and larger microscale objects will be pushed towards the microchannel opposing sidewalls 126 due to a shear-gradient lift force resulting from the Poiseuille characteristics of the laminar main fluid flow.

However, if/when a fluidic medium (e.g., a blood sample) is introduced into the microfluidic object isolation device 18 when the microfluidic object isolation device 18 is in the compressed state such that the microchannels 22 are in the compressed state having the second geometrical shape and size, the curved microchannel bypass zones 22B, a transverse pressure gradient within the microchannels 22 will impart centrifugal forces on the moving main fluid flow, guiding the smaller and larger microscale elements to change direction. More specifically, due to the second geometrical shape and size of the compressed microchannels 22 within the microchannel bypass zones 22B, these centrifugal forces lead to the formation of the counter-rotating helical secondary flow vortices 138 as shown in FIG. 13. The counter-rotating helical secondary flow vortices 138 create the secondary flows within the main fluid flow, wherein the secondary flow comprising the secondary flow vortices 138 is perpendicular to the main flow. The magnitude of the secondary flow vortices 138 is determined by the Deans number (De) as described above with regard to equations (1), (2) and (3).

Consequently, the secondary flow vortices 138 impart two forces on both the smaller and larger microscale objects, which are: (1) a Dean drag force (FD), and (2) a rotational induced lift force (Fa). The Dean drag force (FD) exerts a lateral drag force that pulls both the smaller and larger microscale objects along streamlines of the secondary flow vortices 138, which causes the smaller and larger microscale objects to circulate about secondary flow vortices streamlines perpendicular to the direction of flow of the main flow (i.e., laterally across the width of the microchannels 22). Importantly, the amount of Dean drag force (FD) exerted on the smaller microscale object and on larger microscale objects is related to the radius of the respective microscale object. Therefore, the smaller radius smaller microscale objects (e.g., RBCs) easily follow the secondary flow vortices 138 and gravitate or migrate to the microchannel bypass zone opposing sidewalls 126A, whereas the larger radius of the larger microscale objects (e.g., CTCs) initially follow but then experience the competing rotational induced lift force (Fa) as they approach shear gradients within the secondary flow vortices 138. The rotational induced lift force (F_{Ω}) pushes the larger microscale objects away from the microchannel bypass zone opposing sidewalls 126A and toward the middle of the microchannels.

Generally, for the larger microscale objects to be influenced by the rotational induced lift force (F_{Ω}) and pushed toward the middle of the microchannels 22, the larger microscale object must a diameter that is 0.3 to 0.7 times the longest cross-sectional dimension of the microchannel 22. Hence, if the smaller or larger microscale objects have a diameter that is less than 0.3 times the longest cross-sectional dimension of the microchannel 22, the respective microscale particles will follow the counter-rotating forces of the secondary flow vortices 138 and be pushed toward the microchannel bypass zone opposing sidewalls 126A. Accordingly, the smaller microscale objects will gravitate or migrate to the opposing sidewalls 126A of the microchannel object bypass zones 22A (e.g., be pushed to the opposing sidewalls 126A of the microchannel object bypass zones 22A) by the counter-rotating forces of the secondary flow vortices 138 and remain with the portion of the main fluid flow that bypasses the capture inlet zones 22C. Conversely, the larger microscale objects will gravitate or migrate to the middle of the microchannels 22 in the microchannel object bypass zones 22A (e.g., be pushed to the middle of the microchannels 22 in the microchannel object bypass zones 22A) due to the competing rotational induced lift forces (F_{Ω}). Consequently, the larger microscale objects will be directed into, or more particularly carried into, the microchannel capture inlet zones 22C and then into the microchannel capture zones 22B by the main fluid flow, whereby the larger microscale objects will be captured as described above.

Once the fluidic medium (e.g., a blood sample) has been processed through the microfluidic object isolation device 18 in the compressed state, whereby the larger microscale objects (e.g., CTCs) have been separated/isolated from the smaller microscale objects (e.g., RBCs), the larger microscale object have been captured within the microchannel capture zones 22B, and the remainder of the fluidic medium (e.g., the blood sample) has been egressed from the compressed microfluidic object isolation device 18, the microfluidic object isolation device 18 can be removed from the load transmission assembly 30. Removing the microfluidic object isolation device 18 can be removed from the load transmission assembly 30 will allow the microfluidic object isolation device 18, and hence the elastomeric bi-stable microstructures 14 and the microchannels 22, to uncompress/decompress and return to the static state. When in the static state, the microchannels 22, particularly the microchannels in the microchannel object capture zones 22B, will return the first geometrical shape and size such that the cross-sectional area of the microchannels in the microchannel object capture zones 22B is larger than the larger microscale objects. Thereafter, the larger microscale objects can be flushed from the microchannel capture zones 22B and from the microfluidic object isolation device 18 by introducing a flushing fluid into the microfluidic object isolation device 18 ingress port 110, via forced flow or natural flow. Consequently, the flushing fluid will flow through the array 110 of pairs 122 of elastomeric bi-stable microstructures 14 in the same direction as the fluidic medium was processed through the array 110 of pairs 122 of elastomeric bi-stable microstructures 14, thereby flushing the larger microscale objects out the egress port 116 of the microfluidic object isolation device 18, whereafter the larger microscale objects can be collected and analyzed.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A microfluidic object isolation device, said microfluidic object isolation device comprising:
a top plate;
a bottom plate;
at least one elastomeric perimeter wall disposed between the top and bottom plates around a perimeter of the top and bottom plates and defining an interior chamber;
an array of elastomeric microstructures formed between the top and bottom plates within the interior chamber, the elastomeric microstructures spaced apart such that fluid flow microchannels are defined between adjacent elastomeric microstructures, wherein the fluid flow microchannels comprise a plurality of object bypass zones and a plurality of object capture zones;
an ingress port structured and operable to ingress a fluidic medium into the interior chamber, the fluidic medium comprising large microscale objects and small microscale objects; and
an egress port structured and operable to egress the fluidic medium from the interior chamber;
wherein the microfluidic object isolation device is compressible from a static state to a capture state whereby the elastomeric microstructures are compressed to alter the fluid flow microchannels from a static shape and size to a capture shape and size whereby the large microscale objects of the fluidic medium are captured within the object capture zones.

2. The device of claim 1, wherein:
each elastomeric microstructure has a perimeter wall comprising a slanted upper section and undercut lower section extending at an angle from the slanted upper section;
the fluid flow microchannels comprise a pair of opposing sidewalls defined by the perimeter walls of adjacent elastomeric microstructures, the fluid flow microchannel opposing sidewalls being uncompressed when the microfluidic object isolation device is in the static state and compressed when the microfluidic object isolation device is in the capture state; and
a static shape and size of the fluid flow microchannels comprises the uncompressed opposing sidewalls, defined by the adjacent uncompressed elastomeric microstructure perimeter walls slanted upper sections and undercut lower sections, having a concave-triangle shape such that the large microscale objects can pass through the object capture zones.

3. The device of claim 2, wherein a capture shape and size of the fluid flow microchannels comprises the compressed opposing sidewalls, defined by the adjacent compressed elastomeric microstructure perimeter walls slanted upper sections and undercut lower sections, having a generally rectangular shape throughout substantially the entire height of the compressed fluid flow microchannels such that the large microscale objects are separated from the small microscale objects in the bypass zones and the large microscale objects are directed into and captured in the object capture zones.

4. The device of claim 3, wherein a lateral cross-sectional plane of each elastomeric microstructure that is substantially parallel to the top and bottom plates of the microfluidic object isolation device has a perimeter shape comprising a curved bypass portion, a capture inlet portion and a capture portion such that the perimeter wall of each elastomeric microstructure comprises a curved bypass section, an inlet section and a capture section.

5. The device of claim 4, wherein:
the curved bypass portion of the perimeter shape of the lateral cross-sectional plane of each elastomeric microstructure comprises a curved bell-shaped dome portion;
the capture inlet portion of the perimeter shape of the lateral cross-sectional plane of each elastomeric microstructure comprises a straight inlet segment of a bifurcated base portion from which the curved bell-shaped dome portion extends; and
the capture portion of the perimeter shape of the lateral cross-sectional plane of each elastomeric microstructure comprises a straight capture segment extending at an angle from the straight inlet segment,
such that the perimeter wall of each elastomeric microstructure comprises a curved bell-shaped dome section, a straight inlet section and a straight capture section.

6. The device of claim 4, wherein the array of elastomeric microstructures comprises a plurality of elastomeric microstructure pairs, the elastomeric microstructures of each pair aligned to be mirror images of each other such that:
the capture sections of the perimeter walls of the pair of elastomeric microstructures are substantially parallel and define the object capture zones of the fluid flow microchannels;
the inlet sections of the perimeter walls of the pair of elastomeric microstructures define capture inlet zones of the fluid flow microchannels; and
the curved bypass sections of the perimeter walls of each pair of elastomeric microstructures define the object bypass zones of the fluid flow microchannels disposed between the curved bypass sections of the perimeter walls of the elastomeric microstructures of adjacent pairs of elastomeric microstructures.

7. A system for isolating large microscale objects from small microscale objects in a fluidic medium and capturing the large microscale objects, said system comprising:
a load transmission assembly press, the press comprising:
a top platen;
a compression platen;
a base platen; and
a compression load assembly;
a microfluidic object isolation device, the microfluidic object isolation device comprising:
a top plate;
a bottom plate;
at least one elastomeric perimeter wall disposed between the top and bottom plates around a perimeter of the top and bottom plates and defining an interior chamber;
an array of elastomeric microstructures formed between the top and bottom plates within the interior chamber, the elastomeric microstructures spaced apart such that fluid flow microchannels are defined between adjacent elastomeric microstructures, wherein the fluid flow microchannels comprise a plurality of object bypass zones and a plurality of object capture zones;
an ingress port structured and operable to ingress a fluidic medium into the interior chamber, the fluidic medium comprising large microscale objects and small microscale objects; and
an egress port structured and operable to egress the fluidic medium from the interior chamber; and
a load transmission assembly removably disposable between the top platen and the base platen, the load transmission assembly structured and operable to receive the microfluidic object isolation device in a static state,
wherein the compression load assembly is structured and operable to move the compression platen to compress the load transmission device such that the microfluidic object isolation device is compressed from the static state to a capture state whereby the elastomeric microstructures are compressed to alter the fluid flow microchannels from a static shape and size to a capture shape and size whereby the large microscale objects of the fluidic medium are captured within the object capture zones.

8. The system of claim 7, wherein:
each elastomeric microstructure has a perimeter wall comprising a slanted upper section and undercut lower section extending at an angle from the slanted upper section;
the fluid flow microchannels comprise a pair of opposing sidewalls defined by the perimeter walls of adjacent elastomeric microstructures, the fluid flow microchannel opposing sidewalls being uncompressed when the microfluidic object isolation device is in the static state and compressed when the microfluidic object isolation device is in the capture state; and
a static shape and size of the fluid flow microchannels comprise the uncompressed opposing sidewalls, defined by the adjacent uncompressed elastomeric microstructure perimeter walls slanted upper sections and undercut lower sections, having a concave-triangle shape such that the large microscale objects can pass through the object capture zones.

9. The system of claim 8, wherein the capture shape and size of the fluid flow microchannels comprise the compressed opposing sidewalls, defined by the adjacent compressed elastomeric microstructure perimeter walls slanted upper sections and undercut lower sections, having a generally rectangular shape throughout substantially the entire height of the compressed fluid flow microchannels such that the large microscale objects are separated from the small microscale objects in the bypass zones and the large microscale objects are directed into and captured in the object capture zones.

10. The system of claim 9, wherein a lateral cross-sectional plane of each elastomeric microstructure that is substantially parallel to the top and bottom plates of the microfluidic object isolation device has a perimeter shape comprising a curved bypass portion, a capture inlet portion and a capture portion such that the perimeter wall of each elastomeric microstructure comprises a curved bypass section, an inlet section and a capture section.

11. The system of claim 10, wherein:
the curved bypass portion of the perimeter shape of the lateral cross-sectional plane of each elastomeric microstructure comprises a curved bell-shaped dome portion;
the capture inlet portion of the perimeter shape of the lateral cross-sectional plane of each elastomeric microstructure comprises a straight inlet segment of a bifurcated base portion from which the curved bell-shaped dome portion extends; and
the capture portion of the perimeter shape of the lateral cross-sectional plane of each elastomeric microstructure comprises a straight capture segment extending at an angle from the straight inlet segment,
such that the perimeter wall of each elastomeric microstructure comprises a curved bell-shaped dome section, a straight inlet section and a straight capture section.

12. The system of claim 10, wherein the array of elastomeric microstructures comprises a plurality of elastomeric microstructure pairs, the elastomeric microstructures of each pair aligned to be mirror images of each other such that:
the capture sections of the perimeter walls of the pair of elastomeric microstructures are substantially parallel and define the object capture zones of the fluid flow microchannels;
the inlet sections of the perimeter walls of the pair of elastomeric microstructures define capture inlet zones of the fluid flow microchannels; and
the curved bypass sections of the perimeter walls of each pair of elastomeric microstructures define the object bypass zones of the fluid flow microchannels disposed between the curved bypass sections of the perimeter walls of the elastomeric microstructures of adjacent pairs of elastomeric microstructures.

13. The system of claim 7, wherein the load transmission assembly is further structured and operable to retain the microfluidic object isolation device in the capture state and selectively allow the microfluidic object isolation device to return to the static state whereby the elastomeric microstructures decompress to return the object capture zones to the static shape and size whereby the large microscale objects are released and can be egressed through the egress port.

14. The system of claim 7, wherein the load transmission assembly comprises a compression target region block structured and operable to compress a target region of the microfluidic object isolation device such that only a target region of the elastomeric microstructures are compressed to alter the fluid flow microchannels from the static shape and size to the capture shape and size.

15. A method for separating large microscale objects from small microscale objects in a fluidic medium and capturing the large microscale objects, said method comprising:
compressing at least a portion of an array of elastomeric microstructures of a microfluidic object isolation device such that at least a portion of fluid flow microchannels defined by the elastomeric microstructures are altered from a static shape and size when the elastomeric microstructures are uncompressed to a capture shape and size when elastomeric microstructures are compressed, wherein the microfluidic object isolation device comprises:
a top plate;
a bottom plate;
at least one elastomeric perimeter wall disposed between the top and bottom plates around a perimeter of the top and bottom plates and defining an interior chamber;
the array of elastomeric microstructures formed between the top and bottom plates within the interior chamber, the elastomeric microstructures spaced apart such that the fluid flow microchannels are defined between adjacent elastomeric microstructures, wherein the fluid flow microchannels comprise a plurality of object bypass zones and a plurality of object capture zones;
an ingress port structured and operable to ingress the fluidic medium into the interior chamber; and
an egress port structured and operable to egress the fluidic medium from the interior chamber;
ingressing a fluidic medium comprising large microscale objects and small microscale objects into the interior chamber of a microfluidic object isolation device via the ingress port such that the fluidic medium flows through the fluid flow microchannels;
separating the large microscale objects from the small microscale objects via flow vortices generated by the capture shape and size of the compressed fluid flow microchannels;
directing the small microscale objects into the bypass zones of the compressed fluid flow microchannels, and directing the large microscale objects into the capture zones of the compressed fluid flow microchannels via the flow vortices generated by the capture shape and size of the compressed fluid flow microchannels such that the large microscale objects are captured within the capture zones of the compressed fluid flow microchannels;
egressing the small microscale objects from the interior of a microfluidic object isolation device via the egress port;
decompressing the at least a portion of the array of elastomeric microstructures of a microfluidic object isolation device such that the at least a portion of fluid flow microchannels are altered from the capture shape and size to the static shape and size such that large microscale objects are released from within the capture zones of the uncompressed fluid flow microchannels; and
egressing the large microscale objects from the interior of a microfluidic object isolation device via the egress port.

16. The method of claim 15, wherein the fluid flow microchannels comprise a pair of opposing sidewalls defined by perimeter walls of adjacent elastomeric microstructures and the elastomeric microstructure perimeter walls comprise a slanted upper section and undercut lower section extending at an angle from the slanted upper section,
wherein compressing the at least a portion of an array of elastomeric microstructures such that at least a portion of fluid flow microchannels are altered from the static shape and size the capture shape and size comprises altering the fluid flow microchannels:
from the static shape and size wherein the fluid flow microchannels comprise the uncompressed opposing sidewalls, defined by the adjacent uncompressed elastomeric microstructure perimeter walls slanted upper sections and undercut lower sections, having a concave-triangle shape,
to the capture shape and size wherein the fluid flow microchannels comprise the compressed opposing sidewalls, defined by the adjacent compressed elastomeric microstructure perimeter walls slanted upper sections and undercut lower sections, having a generally rectangular shape throughout substantially the entire height of the compressed fluid flow microchannels.

17. The method of claim 16, wherein the perimeter wall of each elastomeric microstructure comprises a curved bypass section, an inlet section and a capture section, the array of elastomeric microstructures comprises a plurality of elastomeric microstructure pairs aligned to be mirror images of each other, the bypass zones are defined by the curved bypass sections of adjacent elastomeric microstructures, and the object capture zones are defined by the capture sections of adjacent elastomeric microstructures,
wherein separating the large microscale objects from the small microscale objects via flow vortices comprises creating stabilized secondary flow vortices within the bypass zones of fluid flow microchannels by increasing a Deans number when the fluid flow microchannels are compressed to the capture shape and size, wherein the stabilized secondary flow vortices separate the large microscale objects from the small microscale objects.

18. The method of claim 17, wherein directing the small microscale objects into the bypass zones and the large microscale objects into the capture zones via the flow vortices comprises creating the stabilized secondary flow vortices within the bypass zones, wherein the stabilized secondary flow vortices direct the small microscale objects into the bypass zones and the large microscale objects into the capture zones.

19. The method of claim 18, wherein capturing the large microscale objects within the capture zones comprises altering the fluid flow microchannels to the generally rectangular capture shape and size such that the geometric dimensions of the generally rectangular capture shape and size of the fluid flow microchannels within the capture zones are smaller than a diameter of the large microscale objects.

20. The method of claim 19, wherein releasing the large microscale objects from within the capture zones comprises decompressing the at least a portion of the array of elastomeric microstructures such that he capture zones of the fluid flow microchannels are returned to concave-triangle shape static shape and size such that the geometric dimensions of the concave-triangle shape static shape and size of the fluid flow microchannels within the capture zones are larger than the diameter of the large microscale objects.
